(19) United States
(12) Patent Application Publication
(10) Pub. No.: US 2021/0103838 A1
(43) Pub. Date: Apr. 8, 2021

(54) EXPLAINABILITY FRAMEWORK AND METHOD OF A MACHINE LEARNING-BASED DECISION-MAKING SYSTEM

(71) Applicant: Tookitaki Holding Pte. Ltd., Singapore (SG)

(72) Inventors: Luo YUAN, Singapore (SG); Abhishek CHATTERJEE, Singapore (SG)

(73) Assignee: Tookitaki Holding Pte. Ltd., Singapore (SG)

(21) Appl. No.: 16/593,814

(22) Filed: Oct. 4, 2019

(51) Int. Cl. G06N 5/04; G06N 20/00; G06K 9/62; G06Q 10/06

(52) U.S. Cl. CPC G06N 5/045; G06Q 10/0637; G06K 9/6218; G06N 20/00

(57) ABSTRACT

The present invention provides a framework for explainability of a machine learning-based decision-making system. The framework calculates the directional contribution and sensitivity of each feature for each prediction. In addition, the framework provides decision rules to explain each prediction made by the decision-making system. Furthermore, the framework displays a readable explanation of the decisions made by the decision-making system via mapping the model explanation to the business context.

### TECHNICAL FIELD

The present invention relates to the field of explainability and, in particular, relates to a framework and method of explainability of a machine learning-based decision-making system.

### INTRODUCTION

Digitalization has led to the use of machine learning algorithms across business units in the banking and financial services industries, where these algorithms are leveraged to improve the performance of decision-making systems. Nowadays, the financial industry is highly digitalized. On one hand, machine learning algorithms have become increasingly necessary as it is tougher and costlier to get enough human resources to deal with the exponential growth of data. On the other, the abundance of data gives a huge advantage for training algorithms with machine learning techniques to make them better and more reliable.

Therefore, an increasing number of financial services are adopting machine learning technologies these days, and the impact is already evident in various areas. The use of machine learning algorithms in financial services reduces operational costs through process automation. In addition, the use of machine learning algorithms in financial services has increased revenue by enabling efficient processes and higher productivity, and enhanced compliance and security. Furthermore, the applications of machine learning tools in finance have a wide range, including fraud, trading, customer service, credit scoring, process automation, compliance, and the like.

Moreover, the need for machine learning algorithms extends to anti-money laundering (AML). This machine learning-based AML application is built to solve two problems. First, the machine learning-based AML application reduces false alerts generated by the current rule-based alert systems. Second, the machine learning-based AML application detects unknown suspicious cases missed out by rule-based systems. Due to the nature of the data and the problem, where known patterns can have labels from investigated alerts while unknown patterns do not have labeled data, both supervised and unsupervised approaches are applied in the AML application.

### SUMMARY

In a first example, a computer-implemented method for explainability of a machine learning-based decision-making system is provided. The computer-implemented method includes a first step to receive data at the decision-making system. The computer-implemented method includes another step to apply feature engineering on the decision data at the decision-making system. The computer-implemented method includes yet another step to extract one or more rules of the decision made by the decision-making system at an explainability system. The computer-implemented method includes yet another step to display a readable explanation of the decision made by the decision-making system based on mapping of the one or more rules with business context at the explainability system. The decision data includes customer data, past transaction data, and final decision data. The decision-making system is connected with the explainability system. Feature engineering is applied to transform the raw data to input features consumed by machine learning models. The extraction of the one or more rules is done at mathematical model profiler applied to one or more machine learning algorithms. The readable explanation is displayed on a display screen of a communication device.

In an embodiment of the present disclosure, the one or more machine learning algorithms include tree-based models, feed-forward neural network, clustering methods, and linear model.

In an embodiment of the present disclosure, the customer data includes business type, customer address, customer age, customer occupation, and customer salary.

In an embodiment of the present disclosure, the past transaction data used in the anti-money laundering solution in reference includes account number, branch name, card number, transaction location, transaction date, transaction time, amount debited, balance, amount credited, and the amount transferred.

In an embodiment of the present disclosure, the final decision data includes customer name, account number, decision, reason for decision, and transaction ID.

In an embodiment of the present disclosure, the feature contribution of each feature in a tree-based model is calculated for each node of the one or more decision trees. The calculation is done by going through the decision path and aggregating the contribution from each node. The feature importance is calculated to identify the contribution of each feature in making a decision by the system.

In an embodiment of the present disclosure, the computer-implemented method includes another step to aggregate the path of each of the one or more decision trees. The aggregation is done to identify the directional feature importance of each of the features for each of the one or more decision trees.

In an embodiment of the present disclosure, the computer-implemented method includes another step to map the one or more rules with the business context. The mapping is done based on the business dictionary and the definition of each of the features. The one or more rules are mapped in order to generate a readable explanation.

In an embodiment of the present disclosure, the computer-implemented method includes another step to integrate the business dictionary for the business context. The business dictionary is used for generating a readable explanation and is updated periodically.

In a second example, a computer system is provided. The computer system may include one or more processors and a memory coupled to the one or more processors. The memory may store instructions which, when executed by the one or more processors, may cause the one or more processors to perform a method to explain a machine learning-based decision-making system. The method includes a first step to receive decision data at a decision-making system. The method includes another step to apply feature engineering on the decision data at the decision-making system. The method includes yet another step to extract one or more rules of the decision made by the decision-making system at the explainability system. The method includes yet another step to display a readable explanation of the decision made by the decision-making system based on mapping of the one or more rules with the business context at the explainability system. The decision data includes customer data, past transaction data, and final decision data. The decision-making system is connected with the explainability system. Feature engineering is applied to transform the raw data to input features consumed by machine learning models. The extraction of the one or more rules is done by aggregation of each of the one or more decision trees. The extraction of one or more rules is done at mathematical model profiler using one or more machine learning algorithms. The readable explanation is displayed on a display screen of a communication device.

In an embodiment of the present disclosure, the one or more machine learning algorithms include tree-based models, feed-forward neural network, clustering methods and linear model.

In an embodiment of the present disclosure, the customer data includes customer name, customer address, customer age, customer occupation, customer location, customer salary, customer experience, number of loans, opening data, account number, branch name and card number.

In an embodiment of the present disclosure, the past transaction data includes account number, branch name, card number, transaction location, transaction date, transaction time, amount debited, balance, amount credited and amount transferred. The amount transferred is calculated on a periodic basis.

In an embodiment of the present disclosure, the final decision data includes customer name, account number, decision, reason for decision, and transaction ID.

In an embodiment of the present disclosure, the feature importance is calculated for each node of the one or more decision trees, to identify the contribution of each feature to decisions made by the decision-making system. The calculation is done by processing the model parameters of each node of the one or more decision trees.

In an embodiment of the present disclosure, the computer system includes another step to aggregate the path of each of the one or more decision trees at the explainability system. The aggregation is done to identify the directional feature importance of each of the features for each of the one or more decision trees.

In an embodiment of the present disclosure, the computer system includes another step to map the one or more rules with the business context at the explainability system. The mapping is done based on the business dictionary and the definition of each of the features. The one or more rules are mapped in order to generate a readable explanation.

In an embodiment of the present disclosure, the computer system includes another step to integrate the business dictionary for the business context. The business dictionary is used for generating a readable explanation, and the dictionary is updated periodically.

In a third example, a non-transitory computer-readable storage medium is provided. The non-transitory computer-readable storage medium encodes computer executable instructions which, when executed by at least one processor, may perform a method to explain a machine learning-based decision-making system. The method includes a first step to receive decision data from the decision-making system at a computing device. The method includes another step to apply feature engineering on the decision data at the decision-making system. The method includes yet another step to extract one or more rules of the decision made by the decision-making system at the computing device. The method includes yet another step to display a readable explanation of the decision made by the decision-making system based on mapping of the one or more rules with the business context at the computing device. The decision data includes customer data, past transaction data, and final decision data. The decision-making system is connected with the explainability system. Feature engineering is applied to transform the raw data to input features consumed by machine learning models. The extraction of the one or more rules is done by aggregation of each of the one or more decision trees. The extraction of one or more rules is done at mathematical model profiler using one or more machine learning algorithms. The readable explanation is displayed on a display screen of a communication device.

### BRIEF DESCRIPTION OF DRAWINGS

Having thus described the invention in general terms, reference will now be made to the accompanying figures, wherein:

FIG. 1A illustrates an interactive computing environment for explainability of a machine learning-based decision-making system, in accordance with various embodiments of the present invention;

FIG. 1B illustrates a block diagram of an explainability system, in accordance with various embodiments of the present invention;

FIG. 1C illustrates a block diagram of explainability methods of the explainability system, in accordance with various embodiments of the present invention;

FIG. 2 illustrates a flow chart of a business explainability module, in accordance with various embodiments of the present invention;

FIG. 3 illustrates an example of business explainability for AML, in accordance with various embodiments of the present invention;

FIG. 4 illustrates a flow chart of a method to explain a machine learning-based decision-making system, in accordance with various embodiments of the present invention; and

FIG. 5 illustrates a block diagram of a computing device, in accordance with various embodiments of the present invention.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

The premise for the present invention is that the complexity of machine learning models is usually high. The high complexity of machine learning models becomes a hindrance for many financial institutions to adopt machine learning tools in their processes for one or more reasons. In an example, a reason of the one or more reasons include that financial institutions have comparatively high regulatory and compliance requirements. In addition, transparency is required in the decisions and the financial institutions should know exactly why a decision was taken. In another example, another reason of the one or more reasons include that prediction of the machine learning models has to be reliable and interpretable for end-users who are usually non-technical/business persons.

The above mentioned one or more reasons are addressed in the present invention. In addition, banking and financial services companies are subject to strict regulations and explanations are expected for the decisions taken. It is necessary to explain the decisions taken by the algorithms, although adopting machine learning techniques and algorithms streamlines and expedites the decision-making process. Furthermore, algorithms may increasingly be complex and opaque to meet these expectations. This complexity obscures the reasons behind the decisions taken by the algorithms. The black-box nature of highly accurate algorithms precludes the use of these algorithms in such industries. Moreover, it is imperative to design self-explanatory algorithms or devise certain frameworks that would explain existing algorithms in order to make high-performing algorithms more transparent.

The present invention explains the characteristics of an ideal explanation. In an embodiment of the present disclosure, explanations are contrastive. In an example, humans usually need an answer for “Why did X happen instead of Y?” in contrast to “Why did X happen?”. In another example, people are not interested in looking at what rejected or approved profiles generally look like when a loan application is rejected. Instead, people are more interested in knowing what changes to the features of their profiles would lead to acceptance.

In another embodiment of the present disclosure, explanations are based on abnormal causes. In an example, abnormal causes are causes that had a small likelihood but happened anyway. In addition, removing the abnormal causes would have changed the outcome a lot. Further, humans consider these kinds of “abnormal” causes to be good explanations.

In yet another embodiment of the present disclosure, good explanations are general. In addition, a cause that can explain a lot of events is very general and could be considered as a good explanation. In an example, “The bigger the house the more expensive it is” could be a good general explanation for why houses are expensive or cheap.

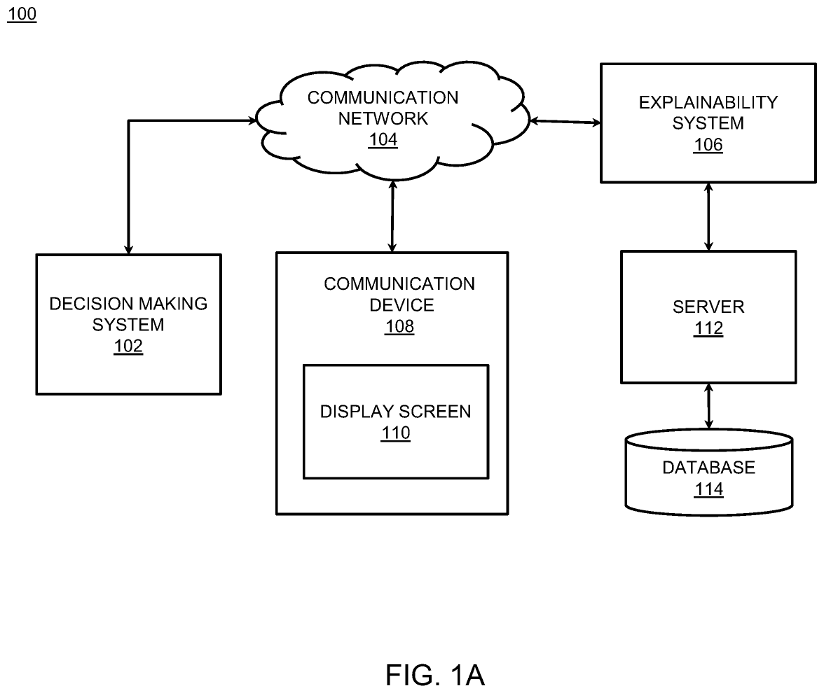

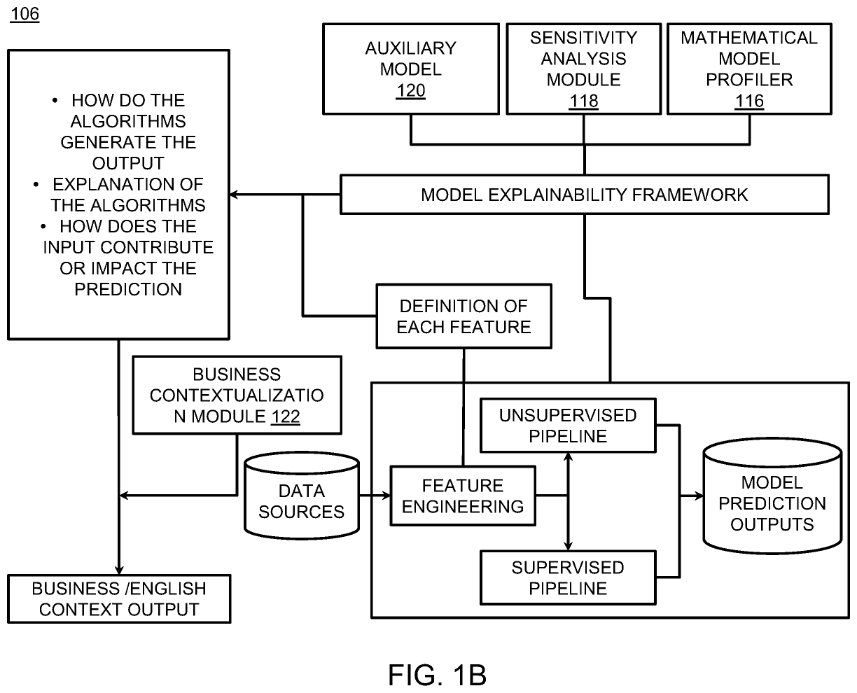

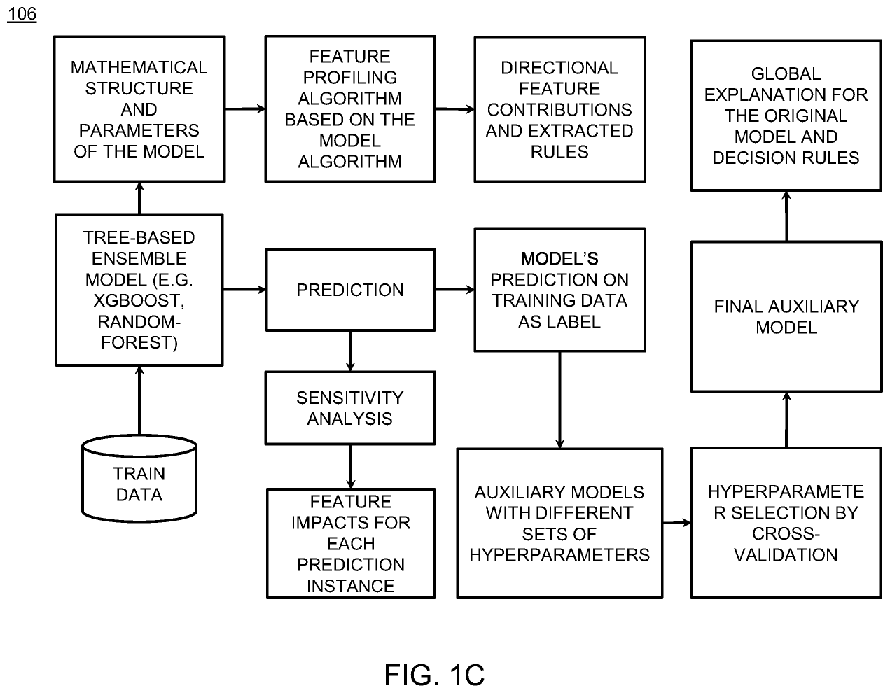

FIG. 1A illustrates a block diagram 100 of an interactive computing environment for explainability of a machine learning-based decision-making system, in accordance with various embodiments of the present invention. The interactive computing environment 100 includes a decision-making system 102, a communication network 104 and an explainability system 106. In addition, the interactive computing environment 100 includes a communication device 108, a display screen 110, a server 112 and a database 114.

The decision-making system 102 is any system which uses machine learning for decision making based on one or more sets of data. In general, machine learning is the creation of intelligent machines that work and reacts like humans. In an embodiment of the present disclosure, the decision-making system 102 is any system which uses machine learning for decision-making based on supervised learning. In an embodiment of the present disclosure, the decision-making system 102 is any system which uses machine learning for decision making based on unsupervised learning. In general, machine learning is a technique to train the machine to learn how to perform different tasks. The tasks include but may not be limited to training the model to understand different patterns from the set of data. The training is performed by using supervised learning or unsupervised learning of the model. In general, supervised learning is the task of training the model based on a set of example pair data. Supervised learning infers from the labeled set of example pair data. In general, unsupervised learning involves learning from one or more commonalities in the data and provides results based on the presence or absence of the one or more commonalities in each data of the set of data. Unsupervised learning involves learning from the set of data that has not been labeled, classified or categorized.

In an example, the decision-making system 102 is a machine learning-based anti-money laundering system. The anti-money laundering system is used by financial institutions to analyze data and detect suspicious transactions. The anti-money laundering system detects suspicious transactions and provides alerts based on the analysis of the data. In general, money laundering is a process by which illegitimate money is converted into legitimate money by performing a complex sequence of banking transfer or commercial transfer. In another example, the decision-making system 102 may be a machine learning system for any other known application for taking any kind of decision. The decision-making system 102 is associated with the communication network 104 to transfer and receive data.

The interactive computing environment 100 includes the communication network 104. The communication network 104 is used to transfer and receive data between components as shown in FIG. 1A. The communication network 104 facilitates in establishing a connection between the decision-making system 102 and the explainability system 106. Also, the communication network 104 provides network connectivity to the communication device 108. In an example, the communication network 104 uses protocol to connect the communication device 108 to the explainability system 106 and the decision-making system 102. The communication network 104 connects the communication device 108 to the explainability system 106 and the decision-making system 102 using 2G, 3G, 4G, Wifi, and the like. In an embodiment of the present disclosure, the communication network 104 may be any type of network that provides internet connectivity to the communication device 108. In an embodiment of the present disclosure, the communication network 104 is a wireless mobile network. In another embodiment of the present invention, the communication network 104 is a wired network connection. In yet another embodiment of the present invention, the communication network 104 is a combination of the wireless and the wired network for optimum throughput of data transmission.

In addition, the interactive computing environment 100 includes the explainability system 106. The explainability system 106 provides explainability of the decision made by the decision-making system 102. The explainability system 106 performs one or more tasks to explain the decision made by the decision-making system 102. The one or more tasks include but may not be limited to extracting one or more rules, mapping, integrating, and the like. The explainability system 106 is used by a user. The user includes any person who is interested to understand the reason for any decision made by the decision-making system 102. In an example, the user includes a banking company or a financial services company which is interested to understand the decision made by an anti-money laundering system.

The user accesses the explainability system 106 on the communication device 108. In an embodiment of the present disclosure, the communication device 108 is a portable communication device. In an example, the portable communication device is a laptop, smartphone, tablet, PDA, and the like. In another embodiment of the present invention, the communication device is a fixed communication device. In an example, the fixed communication device includes a desktop, a workstation, and the like. In an embodiment of the present disclosure, the communication device is a global positioning system (GPS)-enabled device. In general, the global positioning system (GPS) facilitates to identify location of the communication device 108. The global positioning system (GPS) helps locate the location where the transaction has occurred from the account.

The communication device 108 performs computing operations based on the operating system installed inside the one or more communication devices. In general, the operating system is system software that manages computer hardware and software resources and provides common services for computer programs. In addition, the operating system acts as an interface for software installed inside the communication device 108 to interact with hardware components of the communication device 108.

In an embodiment of the present disclosure, the operating system installed inside the communication device 108 is a mobile operating system. In an embodiment of the present disclosure, the communication device 108 performs computing operations based on any suitable operating system designed for the communication device 108. In an example, operating system includes Windows, Android, Symbian, Bada, iOs, and BlackBerry. In an embodiment of the present disclosure, the operating system is any operating system suitable for performing computation and provides an interface to the user on the communication device 108. In an embodiment of the present disclosure, the communication device 108 operates on any version of the particular operating system of the above-mentioned operating systems. The communication device 108 provides a user interface to the user on a display screen 110.

The display screen 110 is used to display content to the user related to the explainability system 106. In an embodiment of the present disclosure, the display screen 110 is an advanced vision display panel. The advanced vision display panel can be organic light-emitting diode (OLED), active-matrix organic light-emitting diode (AMOLED), super active-matrix organic light-emitting diode (AMOLED), retina display, haptic touch-screen display, and the like. In another embodiment of the present invention, the display screen 110 is a basic display panel. The basic display panel can be, but may not be limited to, liquid crystal display (LCD), capacitive touch-screen LCD, resistive touch-screen LCD, thin-film transistor liquid crystal display (TFT-LCD), and the like. In an embodiment of the present disclosure, the display screen 110 is a touch-screen display. The touch-screen display is used for taking input from the user using the user interface. The user interacts with the explainability system 106 by using the display screen 110.

The user interacts with the explainability system 106 using the communication device 108 with the facilitation of the communication network 104. The decision-making system 102 receives decision data. The decision data includes but may not be limited to customer data, past transaction data, and final decision data. The customer data includes but may not be limited to customer name, customer address, customer age, customer occupation, customer location, customer salary, customer experience, opening data, closing data, and number of loans. In addition, the customer data includes gender, account number, branch name, card number, and the like. The past transaction data includes but may not be limited to account number, branch name, card number, transaction location, transaction date, transaction time, amount debited, and balance. In addition, the past transaction data include amount credited, amount transferred, online transaction, offline transaction, and the like. In an embodiment of the present disclosure, the past transaction data is already stored in the explainability system 106. In another embodiment of the present invention, the past transaction data is received from third-party databases. The third-party databases include, but may not be limited to, transaction databases, banking databases. The explainability system 106 integrates with the third-party databases in real-time. The integration with the third-party databases is done by sending connection requests to each of the third-party databases. The amount transferred is calculated on a periodic basis. In an example, the amount transferred is calculated hourly, daily, weekly, monthly, quarterly, and the like.

The final decision data includes customer name, account number, reason for decision, amount change, transaction ID, risk, alert, decision, count of alerts and number of accounts. In addition, the final decision data include but may not be limited to location, account summary, forged amount, closing balance, and opening balance.

FIG. 1B illustrates a block diagram of the explainability system 106, in accordance with various embodiments of the present invention. In addition, the explainability system 106 is referred to as an explainability framework. The explainability system 106 includes the mathematical model profiler 116, the sensitivity analysis module 118, the auxiliary model 120 and the business contextualization module 122. The mathematical model profiler 116 is used for performing mathematical operations on each of the one or more decision trees of the decision data. In an embodiment of the present disclosure, the mathematical model profiler 116 performs any other tasks based on the requirement of the explainability system 106. The sensitivity analysis module 118 performs a sensitivity analysis of data in order to calculate the sensitivity of each of the features with respect to the model performance. In an embodiment of the present disclosure, the sensitivity analysis module 118 performs any other tasks based on the requirement of the explainability system 106. The auxiliary model 120 performs the task of selecting and identifying the surrogate model, and the like. In an embodiment of the present disclosure, the auxiliary model 120 performs any other tasks based on the requirement of the explainability system 106. The business contextualization module 122 is used for converting raw data into the business-readable language in order to convert the raw data into user readable explanation. The business contextualization module 122 includes the business dictionary for performing the business explanation of business terms. In an embodiment of the present disclosure, the business contextualization module 122 performs any other tasks based on the requirement of the explainability system 106.

The explainability framework aligns with the insights about the ideal explainability (as mentioned above). In addition, the explainability framework enables facilitation from the financial industry point of view.

The decision-making system 102 applies feature engineering on the decision data. Feature engineering is applied to each of the customer data, the final decision data and the past transaction data of the decision data. In general, feature engineering generates features using domain knowledge to transform the raw data in order to facilitate the working of one or more machine learning algorithms. It is used to generate the features from the decision data for the improved performance of the one or more machine learning algorithms. In general, the one or more machine learning algorithms are used for performing a defined set of tasks in order to generate results based on the input provided to the one or more machine learning algorithms. The one or more machine learning algorithms include tree-based models, feed-forward neural network, clustering methods, and linear model. In an embodiment of the present disclosure, the one or more machine learning algorithms is any other algorithm based on the requirement of the explainability system 106. In an embodiment of the present disclosure, the one or more machine learning algorithms may be any other algorithm used for performing explainability of the decision-making system 102. In addition, the features which have been identified are fed to mathematical model profiler 116 of the explainability system 106. The mathematical model profiler 116 is used for performing mathematical operations like aggregation, passing, weighting, and the like. The mathematical model profiler 116 is used for performing mathematical operation on each of the one or more decision trees of the decision data.

In an example, the decision-making system 102 is the anti-money laundering system. Feature engineering is applied to the data received from the anti-money laundering system to identify the features for performing explainability. The decision data for the anti-money laundering system include number of accounts, customer name, customer age, number of alerts, closing balance, transaction, opening balance, and the like. After applying feature engineering, the features generated are historical alerts, types of account, and aggregated transaction amount. The features generated are stored with a definition of each of the features for performing explainability of the decision-making system 102.

In addition, the explainability system 106 identifies feature importance of each of the features which have been identified by performing feature engineering. The identification is done at the mathematical model profiler 116 of the explainability system 106. In an embodiment, the feature importance for each of the features is identified by using a tree-based model algorithm or feed-forward neural network algorithm of the one or more machine learning algorithms. In another embodiment of the present invention, the feature importance for each of the features is identified by using any other machine learning algorithm. The feature importance is calculated to identify the contribution of each feature to decisions made by the decision-making system 106. In an embodiment of the present disclosure, the importance of each feature is calculated based on its directional feature importance. In an embodiment of the present disclosure, the feature importance for each of the features is identified for the tree-based model. In another embodiment of the present invention, the feature importance for each of the features is identified by using any other model based on the requirement of the explainability system 106. In an embodiment of the present disclosure, the algorithm traverses the tree-based model and generates the explanation for each prediction given by the decision-making system 102.

In an example, the features generated for the anti-money laundering system includes the historical alerts, the types of account, and the aggregated transaction amount. The feature importance of each feature is identified by using the feed-forward neural network. The feature importance for each feature is also identified by creating a pass through each node of one or more layers of the feed-forward neural network. The pass is generated based on the weight of each node of each of the one or more layers of the feed-forward neural network.

Further, the explainability system 106 aggregates the path of each of the one or more decision trees of the decision data. The aggregation is done at the mathematical model profiler 116 of the explainability system 106. In an embodiment of the present disclosure, the aggregation of the path of each of the one or more decision trees is done to identify the directional feature importance for each of the one or more decision trees.

Furthermore, the explainability system 106 extracts one or more rules of the decision made by the decision-making system 102. The extraction of the one or more rules is done based on the aggregation of each of the one or more decision trees. The extraction of the one or more rules is done at the mathematical model profiler 116 of the explainability system 106. Moreover, the explainability system 106 integrates with the business dictionary for the business context. In general, the business dictionary includes the business-related words and meaning of each word. The business context includes the reference to each of the business-related terms in simple meaning and simple business-related word. The one or more rules extracted are fed to the business contextualization module 122. The business contextualization module 122 performs the task of converting technical model explanations into user-readable explanation based on the dictionary meaning of the data.

Also, the explainability system 106 maps the one or more rules with the business context based on the business dictionary and the definition of each of the features. The mapping is performed by the business contextualization module 122. The mapping is done for the one or more rules extracted from the one or more decision trees of the decision data. In an embodiment, the mapping is performed for each of the one or more rules in order to convert the one or more rules into a readable explanation. Also, the explainability system 106 generates a readable explanation to the one or more rules based on the mapping of the one or more rules with the business context. The readable explanation is the explanation of the one or more rules extracted from the decision made by the decision-making system 102. The readable explanation is presented in simple English language using the decision data. In an embodiment of the present disclosure, the readable explanation is the user interface provided for representing an explanation of the decision made by the decision-making system 102 to the user. In an embodiment, the readable explanation includes, but may not be limited to, customer name, number of accounts, account number, alert count, standard transaction deviation, remittance, and fault transaction. In another embodiment of the present invention, the readable explanation includes, but may not be limited to, total amount, total due amount, monthly average, weekly average, high rate 3-month, alert id, debited 3-month, and credited 3-month. The readable explanation includes, but may not be limited to, the English explanation of the decision made by the decision-making system 102. Also, the explainability system 106 displays the readable explanation of the decision made by the decision-making system 102 on the display screen 110 of the communication device 108. In an embodiment of the present disclosure, the readable explanation is displayed on any other communication device. In an embodiment of the present disclosure, the explainability system 106 alerts the user to suspicious activities.

Also, the explainability system 106 performs a sensitivity analysis of the decision data at sensitivity analysis module 118. The sensitivity analysis module 118 performs analysis by using one or more machine learning algorithms. In an embodiment of the present disclosure, the one or more machine learning algorithms include the tree-based models, the feed-forward neural network, and the linear model. The explainability system 106 calculates the sensitivity of the model used for making the decision by the decision-making system 102. In general, the sensitivity of the model is defined as how sensitive the model is to the change of each of the features. The sensitivity is calculated by making small changes in the feature values across the range of the features and measuring the corresponding change in model performance.

Also, the explainability system 106 updates the business dictionary on a periodic basis. The updating is performed in order to keep the business dictionary updated with new terms and their meaning. In an embodiment of the present disclosure, the explainability system 106 defines the interaction metric between each of the features. In an embodiment of the present disclosure, the interaction metric includes each of the features and relations between each of the features with each other. The interaction metric may include, but may not be limited to, the weight of each of the features. Also, the explainability system 106 evaluates the interaction metric using the one or more machine learning algorithms. The evaluation is done to identify the impact of the features by using the correlation between each of the features in the decision data of the decision-making system 102.

In an embodiment of the present disclosure, the explainability system 106 performs global explanation and local explanation of the model used by the decision-making system 102. The global explanation and local explanation are done by the auxiliary model 120 of the explainability system 106. The auxiliary model 120 performs an auxiliary analysis on the data fed to the auxiliary model 120. The explainability system 106 mimics the model used by the decision-making system 102 using the decision data. In an embodiment of the present disclosure, the explainability system 106 selects the optimal model from between the mimic model and the original model of the explainability system 106. In an embodiment of the present disclosure, the optimal model for the decision-making system 102 is selected by using hyperparameter optimization. In general, the hyperparameter is a parameter from a prior distribution; it captures the prior belief before data is observed. The hyperparameter optimization helps optimize the mimic model and the model used by the decision-making system 102 in order to identify the optimal model.

In an embodiment of the present disclosure, the explainability system 106 identifies the surrogate model in order to identify the model used by the decision-making system 102 for performing clustering on the decision data. The identification is done at the auxiliary model 120 of the explainability system 106.

FIG. 1C illustrates a block diagram of explainability methods of the explainability system 106, in accordance with various embodiments of the present invention. The explainability system 106 provides explainability to machine learning algorithms for business users. The explainability system 106 integrates business explainability module for facilitating one or more functions.

In addition, a function of the one or more functions includes enabling users to verify algorithm explainability and outputs more easily and reliably from the business and domain knowledge angle. Further, another function of the one or more functions includes improving the efficiency of business analysts by providing a business context of model prediction and most relevant information. Furthermore, yet another function of the one or more functions includes enabling validation and feedback process of model algorithms to be a continuous practice and constantly improving AI pipeline.

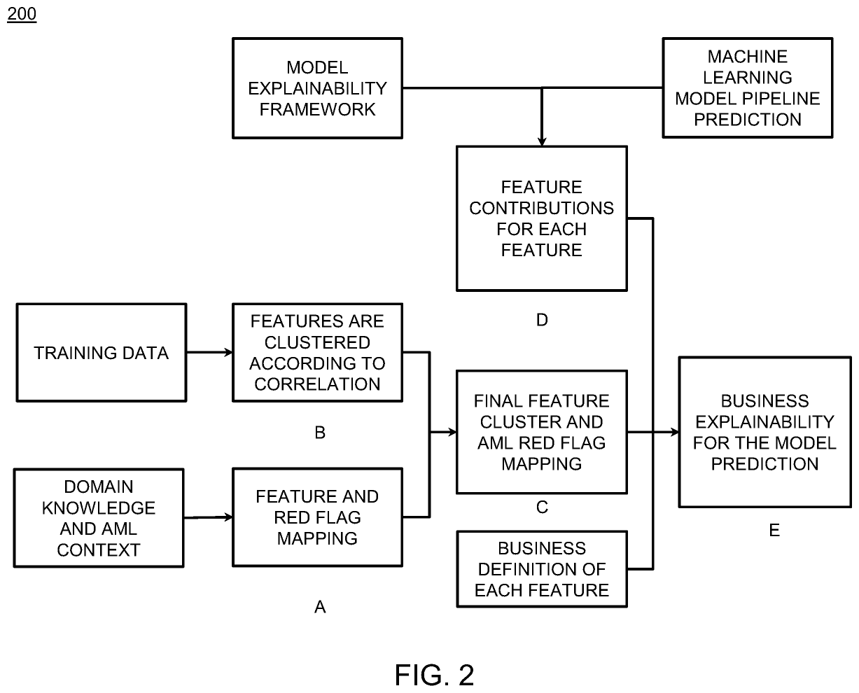

FIG. 2 illustrates a flow chart 200 of a business explainability module, in accordance with various embodiments of the present invention. The business explainability module provides enriched explanations of suspicious behavior predictions with business context to the user.

The mapping between red-flags and features are defined in the anti-money laundering (AML context) (as shown in block A in FIG. 2). In addition, features are clustered into different groups based on feature correlations (as shown in block B in FIG. 2). Further, final mapping is generated based on previous steps and the red-flag is assigned to each feature cluster (as shown in block C in FIG. 2). Furthermore, feature contribution is calculated by the model explainability module for each prediction (as shown in block D in FIG. 2). Moreover, the contribution is calculated for each cluster and red-flag groups based on features that belong to each cluster (as shown in block E in FIG. 2).

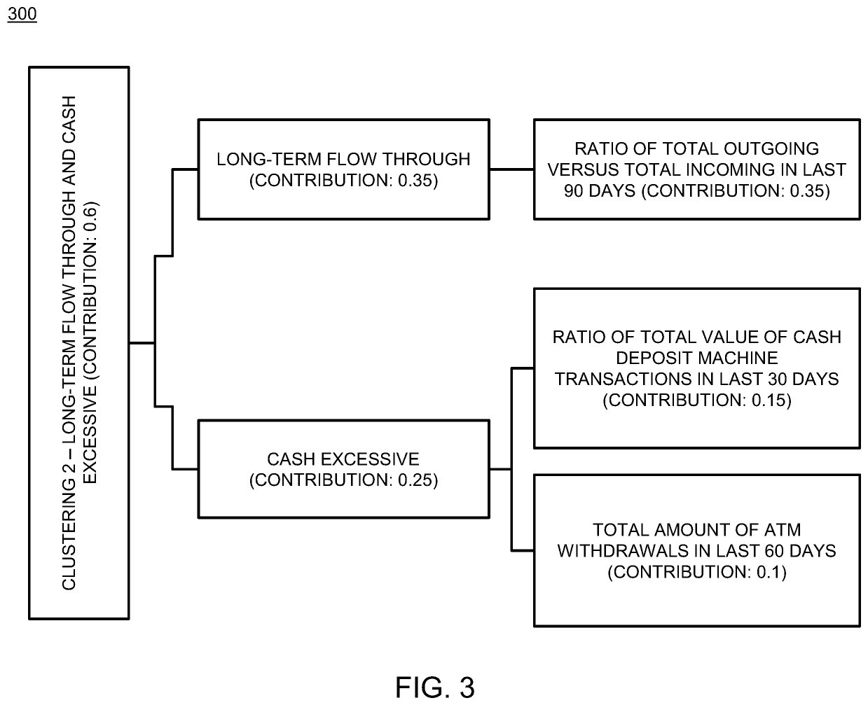

FIG. 3 illustrates an example 300 of business explainability for AML, in accordance with various embodiments of the present invention. The example 300 displays representation of final results (from block E of FIG. 2) to the user.

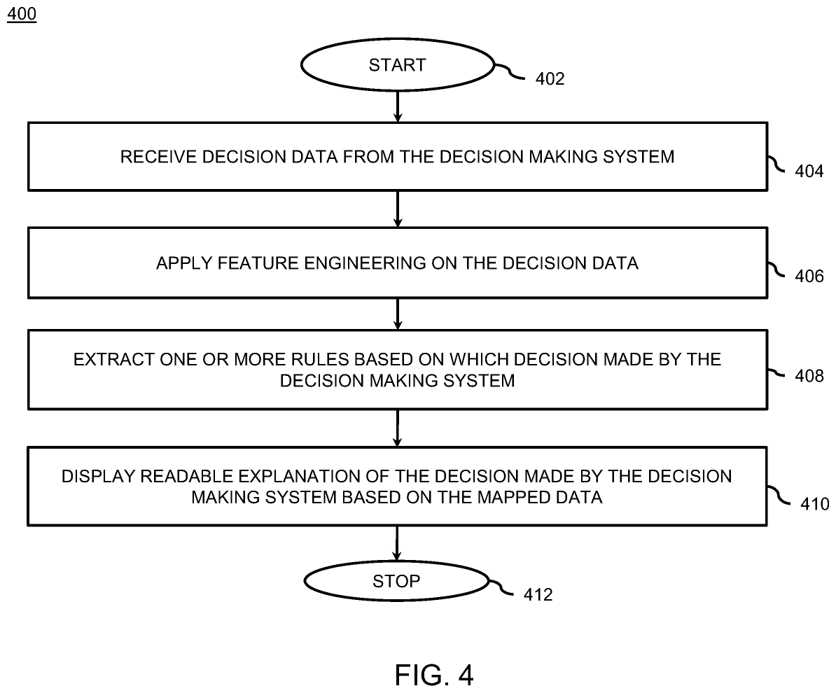

FIG. 4 illustrates a flow chart 400 for explainability of a machine learning-based decision-making system, in accordance with various embodiments of the present invention. It may be noted that to explain the process steps of flowchart 400, references will be made to the system elements of FIG. 1A, FIG. 1B, FIG. 1C, FIG. 2 and FIG. 3. It may also be noted that the flowchart 400 may have fewer or more number of steps.

The flowchart 400 initiates at step 402. Following step 402, at step 404, the explainability system 106 receives decision data from the decision-making system 102. At step 406, the decision-making system 102 applies feature engineering on the decision data. At step 408, the explainability system 106 extracts one or more rules based on which a decision is made by the decision-making system 102. At step 410, the explainability system 106 displays a readable explanation of the decision made by the decision-making system based on the mapped data. The flow chart 400 terminates at step 412.

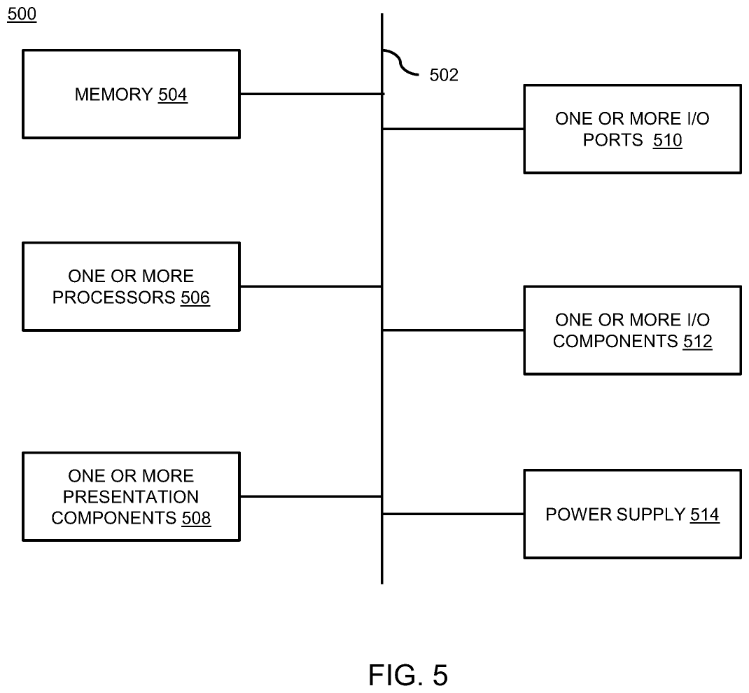

FIG. 5 illustrates a block diagram of a device 500, in accordance with various embodiments of the present invention. The device 500 is a non-transitory computer-readable storage medium. The device 500 includes a bus 502 that directly or indirectly couples the following devices: memory 504, one or more processors 506, one or more presentation components 508, one or more input/output (I/O) ports 510, one or more input/output components 512, and an illustrative power supply 514. The bus 502 represents what may be one or more buses (such as an address bus, a data bus, or a combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary device 500 that can be used in connection with one or more embodiments of the present invention. A distinction is not made between such categories as “workstation,” “server,” “laptop,” “hand-held device,” etc., as all are contemplated within the scope of FIG. 5 and reference to “computing device.”

The computing device 500 typically includes a variety of computer-readable media. The computer-readable media can be any available media that can be accessed by the device 500 and includes both volatile and non-volatile media as well as removable and non-removable media. By way of example, and not limitation, computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The device 500 includes one or more processors 506 that read data from various entities such as memory 504 or I/O components 512. The one or more presentation components 508 present data indications to the user or other devices. Exemplary presentation components include a display device, speaker, printing component, vibrating component, etc. The one or more I/O ports 510 allow the device 500 to be logically coupled to other devices including the one or more I/O components 512, some of which may be built in. Illustrative components include a microphone, joystick, gamepad, satellite dish, scanner, printer, wireless device, etc.

The foregoing descriptions of specific embodiments of the present technology have been presented for the purposes of illustration and description. They are not intended to be exhaustive or to limit the present technology to the precise forms disclosed, and obviously many modifications and variations are possible in light of the above teachings. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A computer-implemented method for explainability of a machine learning-based decision-making system, the computer-implemented method comprising:
receiving, at the decision-making system with a processor, decision data from the decision-making system, wherein the decision data comprises customer data, past transaction data and final decision data, wherein the decision-making system is connected with an explainability system;
applying, at the decision-making system with the processor, feature engineering on the decision data, wherein the feature engineering is applied to transform raw data to input features consumed by machine learning models;
extracting, at the explainability system with the processor, one or more rules of decision made by the decision-making system, wherein the extraction of the one or more rules is done by aggregation of each of one or more decision trees, wherein the extraction of one or more rules is done at mathematical model profiler using one or more machine learning algorithms; and
displaying, at the explainability system with the processor, readable explanation of a decision made by the decision-making system based on mapping of the one or more rules with business context, wherein the readable explanation is displayed on a display screen of a communication device.

2. The computer-implemented method as recited in claim 1, wherein the one or more machine learning algorithms comprises tree-based models, feed-forward neural network, clustering methods and linear model.

3. The computer-implemented method as recited in claim 1, wherein the customer data comprises customer name, customer address, customer age, customer occupation, customer location, customer salary, customer experience, number of loans, opening data, account number, branch name and card number.

4. The computer-implemented method as recited in claim 1, wherein the past transaction data comprises account number, branch name, card number, transaction location, transaction date, transaction time, amount debited, balance, amount credited and amount transferred, wherein the amount transferred is calculated on a periodic basis.

5. The computer-implemented method as recited in claim 1, wherein the final decision data comprises customer name, account number, decision, reason for decision and transaction ID.

6. The computer-implemented method as recited in claim 1, wherein the computer-implemented method comprises a step of calculation of feature importance for each node of the one or more decision trees to identify the contribution of each feature to decisions made by the decision-making system, wherein the calculation is done by processing the model parameters of each node of the one or more decision trees.

7. The computer-implemented method as recited in claim 1, further comprising aggregating at the explainability system with the processor, feature contribution along paths of each of the one or more decision tree features to identify the directional feature importance of each feature.

8. The computer-implemented method as recited in claim 1, further comprising mapping, at the explainability system with the processor, the one or more rules with the business context, wherein the mapping is done based on business dictionary and definition of each of the features, wherein the one or more rules are mapped in order to generate the readable explanation.

9. The computer-implemented method as recited in claim 1, further comprising integrating, at the explainability system with the processor, business dictionary for the business context, wherein the business dictionary is used for generating the readable explanation, wherein the business dictionary is updated periodically.

10. A computer system comprising:
one or more processors; and
a memory coupled to the one or more processors, the memory for storing instructions which, when executed by the one or more processors, cause the one or more processors to perform a method for explainability of a machine learning-based decision-making system, the method comprising:
receiving, at the decision-making system, decision data from the decision-making system, wherein the decision data comprises customer data, past transaction data and final decision data, wherein the decision-making system is connected with an explainability system;
applying, at the decision-making system, feature engineering on the decision data, wherein the feature engineering is applied to transform raw data to input features consumed by machine learning models;
extracting, at the explainability system, one or more rules of decision made by the decision-making system, wherein the extraction of the one or more rules is done by aggregation of each of the one or more decision trees, wherein the extraction of one or more rules is done at mathematical model profiler using one or more machine learning algorithms; and
displaying, at the explainability system, readable explanation of a decision made by the decision-making system based on mapping of the one or more rules with business context, wherein the readable explanation is displayed on a display screen of a communication device.

11. The computer system as recited in claim 10, wherein the one or more machine learning algorithms comprises tree-based models, feed-forward neural network, clustering methods and linear model.

12. The computer system as recited in claim 10, wherein the customer data comprises customer name, customer address, customer age, customer occupation, customer location, customer salary, customer experience, number of loans, opening data, account number, branch name and card number.

13. The computer system as recited in claim 10, wherein the past transaction comprises account number, branch name, card number, transaction location, transaction date, transaction time, amount debited, balance, amount credited and amount transferred, wherein the amount transferred is calculated on a periodic basis.

14. The computer system as recited in claim 10, wherein the final decision data comprises customer name, account number, decision, reason for decision, and transaction ID.

15. The computer system as recited in claim 10, wherein the computer systems calculates feature importance for each node of the one or more decision trees to identify the contribution of each feature to decisions made by the decision-making system, wherein the calculation is done by processing model parameters of each node of the one or more decision trees.

16. The computer system as recited in claim 10, further comprising aggregating, at the explainability system, feature contribution along paths of each of the one or more decision tree features, to identify the directional feature importance of each feature.

17. The computer system as recited in claim 10, further comprising mapping, at the explainability system, the one or more rules with the business context, wherein the mapping is done based on business dictionary and definition of each of the features, wherein the one or more rules are mapped in order to generate the readable explanation.

18. The computer system as recited in claim 10, further comprising integrating, at the explainability system, business dictionary for the business context, wherein the business dictionary is used for generating the readable explanation, wherein the business dictionary is updated periodically.

19. A non-transitory computer-readable storage medium encoding computer-executable instructions that, when executed by at least one processor, performs a method for explainability of a machine learning-based decision-making system, the method comprising:
receiving, at the decision-making system, decision data from the decision-making system, wherein the decision data comprises customer data, past transaction data and final decision data, wherein the decision-making system is connected with an explainability system;
applying, at the decision-making system, feature engineering on the decision data, wherein the feature engineering is applied to transform raw data to input features consumed by machine learning models;
extracting, at the computing device, one or more rules of decision made by the decision-making system, wherein the extraction of the one or more rules is done by aggregation of each of the one or more decision trees, wherein the extraction of one or more rules is done at mathematical model profiler using one or more machine learning algorithms; and
displaying, at the computing device, readable explanation of the decision made by the decision-making system based on mapping of the one or more rules with business context, wherein the readable explanation is displayed on a display screen of a communication device.
